(19) United States
(12) Patent Application Publication
(10) Pub. No.: US 2025/0044087 A1
(43) Pub. Date: Feb. 6, 2025

(54) LEVEL HOLDING DEVICE

(71) Applicant: Kenneth George Walpac, Calgary (CA)

(72) Inventor: Kenneth George Walpac, Calgary (CA)

(21) Appl. No.: 18/363,336

(22) Filed: Aug. 1, 2023

(51) Int. Cl. G01C 15/00; G01C 15/12

(52) U.S. Cl. CPC G01C 15/004; G01C 15/12

(57) ABSTRACT

A level holding device configured to have releasably secured thereto a first laser level and a second laser level wherein the present invention secures the first laser level and second laser level such that lasers emitting therefrom intersect at a ninety degree orientation. The present invention includes a base support member wherein the base support member includes a first portion and a second portion. The first portion and second portion of the base support member are contiguously formed. The first portion and second portion have secured thereto retention clamps that are configured to releasably secure a laser level to the upper surface thereof. The base support member is elevated above the floor on which the level holding device is superposed utilizing a plurality of leg members. The leg members are further configured to be superposed an element protruding upward from the floor.

### FIELD OF THE INVENTION

The present invention relates generally to tool accessories, more specifically but not by way of limitation, a holding device for three beam lasers wherein the present invention is configured to retain two three beam laser devices in order to align the laser levels to produce squares for users to employ during various construction tasks.

### BACKGROUND

When building a new home, performing renovation or engaging in any sort of construction project, on item that is needed is a laser level. There are many different kinds of laser levels but laser levels are very versatile and can be employed in a wide variety of applications. A laser level is a special electronic tool designed to determine how plumb or level either an item or a surface is which is required for many applications. An advantage with a laser level is that the laser is perfectly straight and the accuracy that you get from the laser level is unrivaled, particularly when compared a normal spirit or bubble level. Laser levels emit lasers both vertically and horizontally and three beam lasers are commonly utilized in a variety of applications. One common application of laser levels is for the installation, aligning, and plumbing of walls.

Another application that laser levels are used for is to level and lay floors. Applications such as installation of drop ceilings are common and utilization of a three beam laser level can be helpful to ensure both vertical and horizontal axis are properly aligned. Alignment of doors and windows are another application where laser levels can be employed, as well as installation of items such as but not limited to cabinets. One common need during construction tasks is to mark squares to ensure the installation of an element will be square. While laser levels are effective at determining plumb or level, they cannot mark squares without utilization of an additional element that may require other tools.

Accordingly, there is a need for a laser level holding device that can have releasably secured thereto two three beam laser levels wherein the present invention positions the three beam laser levels so as to mark squares with the laser beams emitted therefrom.

### SUMMARY OF THE INVENTION

It is the object of the present invention to provide a laser level template that is operable to have two laser levels releasably secured thereto wherein the present invention includes a base support member.

Another object of the present invention is to provide a level holding device configured to have two laser levels secured to the upper surface thereof wherein the base support member is planar and rigid having a first portion and a second portion.

A further object of the present invention is to provide a laser level template that is operable to have two laser levels releasably secured thereto wherein the first portion and second portion of the base support member are contiguously formed.

Yet a further object of the present invention is to provide a level holding device configured to have two laser levels secured to the upper surface thereof wherein the base support member includes retention clamps secured to the upper surface of the base support member and extend upward therefrom.

Still another object of the present invention is to provide a laser level template that is operable to have two laser levels releasably secured thereto wherein the bottom surface of the base support member includes leg members extending downward therefrom.

An additional object of the present invention is to provide a level holding device configured to have two laser levels secured to the upper surface thereof wherein the first portion and second portion of the base support member include alignment indicia on the upper surface thereof.

Yet a further object of the present invention is to provide a laser level template that is operable to have two laser levels releasably secured thereto wherein the present invention employs the alignment indicia to guide laser level installation so as to create square intersections of the laser beams emitted from the laser levels.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of the present invention; and

FIG. 2 is a side view of the present invention; and

FIG. 3 is a top perspective view of the present invention with an exemplary laser level secured thereto.

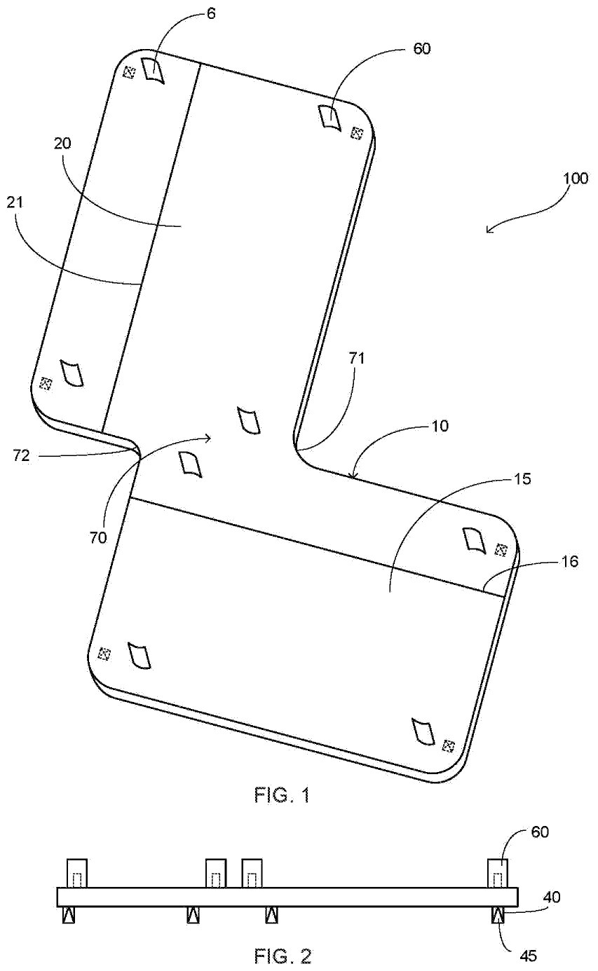

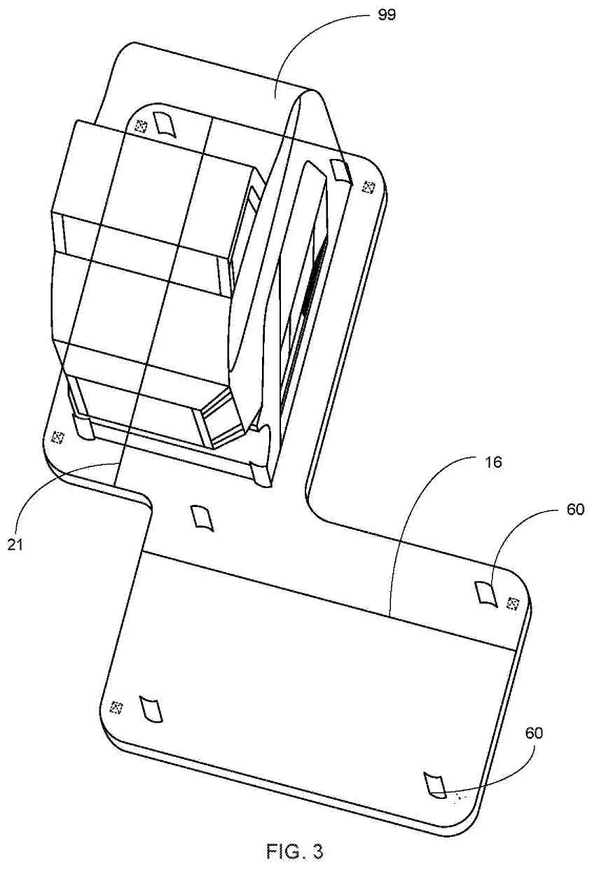

### DETAILED DESCRIPTION

Referring now to the drawings submitted herewith, wherein various elements depicted therein are not necessarily drawn to scale and wherein through the views and figures like elements are referenced with identical reference numerals, there is illustrated a level holding device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the level holding device 100 includes a base support member 10. The base support member 10 is manufactured from a durable rigid material such as but not limited to plastic and is planar in form. It should be understood within the scope of the present invention that the base support member 10 could be provided in alternate sizes and shapes and achieve the desired objective as discussed herein. As is further discussed herein, the base support member 10 is configured to have releasably secured thereto conventional three beam laser levels 99 so as to align lasers emitting therefrom in a square manner so as to provide visual markings to ensure square installation of desired objects and/or elements.

The base support member 10 includes a first portion 15 and second portion 20 wherein the first portion 15 and second portion 20 are contiguously formed and wherein the first portion 15 and second portion 20 are formed at an exact right angle of ninety degrees with respect to each other. The first portion 15 and second portion 20 are formed at center section 70 wherein center section 70 includes contiguous corner edges 71,72 that transition the base support member 10 intermediate the first portion 15 and second portion 20. A first alignment indicia 16 is present on the upper surface off the first portion 15. A second alignment indicia 21 is present on the upper surface of the second portion 20. The first alignment indicia 16 and second alignment indicia 21 are formed so as to be perpendicular to each other having an exact alignment of ninety degrees. The first alignment indicia 16 and second alignment indicia 21 are employed to align exemplary three beam laser levels 99 releasably secured to the base support member 10 so as to ensure that all laser beams emitting from the exemplary three beam laser levels intersect in a perfectly square pattern. It should be understood within the scope of the present invention that two exemplary three beam laser levels 99 are secured to the base support member 10 and only one has been illustrated herein superposed on the second portion 20 for illustrative and understanding purposes. While a first alignment indicia 16 and a second alignment indicia 21 have been illustrated and discussed herein for aligning exemplary three beam laser levels 99, it is further contemplated within the scope of the present invention that the level holding device 100 could employ alternate techniques and/or elements to achieve the desired objective of aligning the exemplary three beam laser levels 99. By way of example but not limitation, the level holding device 100 could utilize notches in addition to and/or in conjunction with the first alignment indicia 16 and second alignment indicia 21.

The base support member 10 further includes a plurality of retention clamps 60. The retention clamps 60 are secured to the upper surface of the base support member 10 and are arranged in a first set and a second set wherein the first set is secured to the first portion 15 and the second set is secured to the second portion 20. The retention clamps 60 are perpendicular to the upper surface of the base support member 10 and extend upward therefrom. While the retention clamps 60 are illustrated herein as being generally C-shaped, it should be understood within the scope of the present invention that the retention clamps 60 could movably secured so as to accommodate alternate brands of three beam laser levels 99. It is further contemplated within the scope of the present invention that the retention clamps 60 could be provided in alternate shapes and/or sizes so as to releasably secure an exemplary three beam laser level 99 to the upper surface of the first portion 15 and second portion 20. While the retention clamps 60 are arranged in a first set and a second set wherein each set has four retention clamps 60 configured to receive and secure an exemplary three beam laser level 99, it is contemplated within the scope of the present invention that as few as two retention clamps 60 could be utilized to releasably secure the exemplary three beam laser level 99.

The base support member 10 includes a plurality of leg members 40 extending downward from the bottom surface thereof. The leg members 40 are manufactured from a rigid material and function to elevate the base support member 10 above the floor on which the base support member 10 is superposed. The leg members 40 are perpendicular to the base support member 10 and it is contemplated within the scope of the present invention that the leg members 40 could be provided in alternate lengths to elevate the base support member 10 at different heights. Formed in the bottom of the leg members 40 are notches 45. Notches 45 are provided so as to mateably engage a track located on a floor such as but not limited to a track for a sliding glass door. The notches 45 are formed so as to superpose a portion of the track so as to allow the base support member 10 to maintain a level position despite having at least one leg member 40 superposed an object such as but not limited to the aforementioned door track. While the notches 45 are illustrated herein as being triangular in form, it is contemplated within the scope of the present invention that the notches 45 could be formed in alternate shapes in order to achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A laser level holding device configured to have a first laser level and a second laser level releasably secured thereto wherein the laser level holding device comprises:
a base support member, said base support member being manufactured from a rigid material, said base support member being planar in manner and having an upper surface and a lower surface, said base support member having a first portion and a second portion, said first portion and said second portion being contiguously formed, said first portion and said second portion being formed at a perpendicular angle with respect to each other;
a first set of retention clamps, wherein said first set of retention clamps are secured to said first portion of said base support member, wherein said first set of retention clamps includes at least two retention clamps, said first set of retention clamps configured to releasably secure the first laser level to said first portion of said base support member;
a second set of retention clamps, wherein said second set of retention clamps are secured to said second portion of said base support member, wherein said second set of retention clamps includes at least two retention clamps, said second set of retention clamps configured to releasably secure the second laser level to said second portion of said base support member; and
wherein laser beams emitting from the first laser level and the second laser level intersect at ninety degrees.

2. The laser level holding device configured to have a first laser level and a second laser level releasably secured thereto as recited in claim 1, wherein said base support member further includes a plurality of leg members, said plurality of leg members secured to the bottom surface of the base support member and extend downward therefrom.

3. The laser level holding device configured to have a first laser level and a second laser level releasably secured thereto as recited in claim 2, wherein said first portion of said base support member further includes a first alignment indicia on the upper surface thereof, said first alignment indicia employed to align the first laser level subsequent securing to said first portion of said base support member.

4. The laser level holding device configured to have a first laser level and a second laser level releasably secured thereto as recited in claim 3, wherein said second portion of said base support member further includes a second alignment indicia on the upper surface of said second portion, said second alignment indicia employed to align the second laser level subsequent securing to said first portion of said base support member.

5. The laser level holding device configured to have a first laser level and a second laser level releasably secured thereto as recited in claim 4, wherein each of said leg members further include a notch, said notch being formed in a bottom surface of said plurality of leg members, said notch configured to superpose an element protruding upward from the floor on which the laser level holding device is superposed.

6. A laser level holding device configured to have releasably secured thereto a first laser level and a second laser level wherein lasers emitting therefrom will intersect at ninety degrees wherein the laser level holding device comprises:
a base support member, said base support member having a first portion and a second portion, said first portion and said second portion being contiguously formed at a center section, said first portion and said second portion being oriented at a ninety degree angle with respect to each other, said base support member having an upper surface and a lower surface;
a first set of retention clamps, said first set of retention clamps being secured to the upper surface of said first portion, said first set of retention clamps consisting of four retention clamps, said first set of retention clamps configured to releasably secure the first laser level to said first portion of said base support member;
a second set of retention clamps, said second set of retention clamps being secured to the upper surface of said second portion, said second set of retention clamps consisting of four retention clamps, said second set of retention clamps configured to releasably secure the second laser level to said second portion of said base support member;
a plurality of leg members, said plurality of leg members secured to the bottom surface of the base support member and extend downward therefrom, said plurality of leg members configured to elevate said base support member above a surface on which the base support member is superposed.

7. The laser level holding device configured to have releasably secured thereto the first laser level and the second laser level wherein lasers emitting therefrom will intersect at ninety degrees as recited in claim 6, wherein each of said plurality of leg members further include a notch, said notch being formed in a bottom surface of said plurality of leg members, said notch configured to superpose an element protruding upward from the floor on which the laser level holding device is superposed.

8. The laser level holding device configured to have releasably secured thereto the first laser level and the second laser level wherein lasers emitting therefrom will intersect at ninety degrees as recited in claim 7, wherein said first portion of said base support member further includes a first alignment indicia on the upper surface thereof, said first alignment indicia employed to align the first laser level subsequent securing to said first portion of said base support member.

9. The laser level holding device configured to have releasably secured thereto the first laser level and the second laser level wherein lasers emitting therefrom will intersect at ninety degrees as recited in claim 8, wherein the four retention clamps of said first set of retention clamps are C-shaped.

10. The laser level holding device configured to have releasably secured thereto the first laser level and the second laser level wherein lasers emitting therefrom will intersect at ninety degrees as recited in claim 9, wherein said second portion of said base support member further includes a second alignment indicia on the upper surface of said second portion, said second alignment indicia employed to align the second laser level subsequent securing to said first portion of said base support member.

11. The laser level holding device configured to have releasably secured thereto the first laser level and the second laser level wherein lasers emitting therefrom will intersect at ninety degrees as recited in claim 10, wherein the four retention clamps of said second set of retention clamps are C-shaped.
